(19) United States
(12) Patent Application Publication
(10) Pub. No.: US 2014/0052476 A1
(43) Pub. Date: Feb. 20, 2014

(54) Points-Based Reward Program For Improving Medication Adherence and Outcomes

(71) Applicant: PharmMD Solutions, LLC, Brentwood, TN (US)

(72) Inventors: Samuel W. Bartholomew, III, Nashville, TN (US); Michael D. Hogue, Mt. Olive, AL (US); Scott A. McDaniel, Murfreesboro, TN (US); Bradley P. Tice, Franklin, TN (US); Joan E. Polk, Antioch, TN (US); Israel E. Rollins, Nashville, TN (US)

(73) Assignee: PharmMD Solutions, LLC, Brentwood, TN (US)

(21) Appl. No.: 14/058,989

(22) Filed: Oct. 21, 2013

Related U.S. Application Data
(63) Continuation of application No. 13/491,956, filed on Jun. 8, 2012, now abandoned.
Application No. 13/491,956 is a continuation of application No. 12/616,605, filed on Nov. 11, 2009, now abandoned.
(60) Provisional application No. 61/120,707, filed on Dec. 8, 2008.

(51) Int. Cl. G06F 19/00; G06Q 30/02

(52) U.S. Cl. CPC G06F 19/3456; G06Q 30/0231
USPC 705/3

(57) ABSTRACT

The invention relates to a method for improving medication adherence and outcomes. The method includes registering a patient in a predetermined manner with a web site thereby creating an associated user profile, manually entering patient medication data and patient health data associated with the user profile, automatically acquiring from a third party and then storing patient medication data and patient health data associated with the user profile and assigning a points based reward based on a comparison of at least one of the manually entered data and the automatically acquired data to a predetermined set of reward criteria parameters.

### CROSS-REFERENCE TO RELATED APPLICATIONS

The present application is a continuation of U.S. Non-Provisional application Ser. No. 13/491,956 filed Jun. 8, 2012, still pending, which is a continuation of U.S. Non-Provisional application Ser. No. 12/616,605 filed Nov. 11, 2009, now abandoned, which claims the benefit of prior U.S. Provisional Application No. 61/120,707, filed Dec. 8, 2008.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention is drawn to subject matter wherein an electrical apparatus and its corresponding methods perform data processing operations in which there is a significant change the data, or for performing calculation operations wherein the apparatus or method is uniquely designed for or utilized in the practice, administration, or management of an enterprise. The present invention is particularly related to an incentive or promotion program designed for price reduction of, or premium credit resulting from, the purchase of a commodity or service. The present invention relates specifically to a computer implemented system or method particularly adapted to establish a points-based reward system wherein consumers may earn points for appropriate medication use and achievement of health outcomes specifically through appropriate medication use.

2. Description of Related Art

Use of prescription medications by consumers in the United States represents over $200 billion in sales annually. This number has risen from $40.3 billion in 1990 and is expected to rise to $497.5 billion by 2015. The primary reason for this increase to date has been increased utilization of medications. Along with the increases in medication spending, spending on other medical costs have also risen significantly, going from $717 billion in 1990 to $1.9 trillion in 2005, and expected to increase to $4.1 trillion by 2015. One of the most significant and growing problems with these costs is that medications are often used inappropriately, so driving up the costs of healthcare through emergency room visits, hospitalizations, and decreased work productivity. As noted by the Institute of Medicine (TOM), there are over 700,000 visits to emergency rooms annually due to adverse events from medication use. The TOM estimates the cost of inappropriate medication use to be $1.25 for every $1.00 spent on medications. See Johnson, J. A. and Bootman, J. L., Drug-related morbidity and mortality: A Cost-of-Illness-Model, Arch. Int. Med., 1995, 155:1949-56.

While the figures mentioned above speak to adverse events from medication use, an equally or more significant problem is that consumers often fail to follow instructions for taking medications. This is especially true for chronic-use medications to treat conditions such as high cholesterol (cholesterolemia), high blood pressure (hypertension), and depression. Treatment of chronic medical conditions often requires months or years of medication therapy. Nevertheless, a significant percentage of patients stop taking medications prescribed for their chronic medical conditions within six months of starting them, often without having enjoyed any of the benefits the medications were intended to provide. Drugs don't work in patients who don't take them. The economic effects of such patient non-compliance include billions of dollars wasted or lost due to physician visits and laboratory tests, time missed from work, and reduced worker productivity.

Rewards programs (e.g., “frequent flyer miles”) are designed primarily to build and ensure consumer loyalty. Airlines commonly award frequent flyer miles to travelers when they use their airline to fly. The miles awarded are most often redeemed for free flights or seat classification upgrades, but some airlines (e.g. United Airlines) allow the purchase of other travel-related items (e.g. hotels, rental cars) and merchandise (e.g. home office equipment, sports equipment, technology, etc.).

Some companies (e.g. IncentOne and Incentive Logic, Inc.) are in the business of designing incentive programs for their clients. The goal is to influence consumer behavior (e.g., buying a particular brand of soap over another) to better comply with the client's business goals (e.g, sell more soap) by rewarding the compliant consumer. Incentive programs are commonly used to engender customer loyalty, provide dealer/distributor incentives, provide sales incentives, boost employee morale, or drive other desired behavior. They have also been used for employee wellness programs, but no programs have been identified that are focused on appropriate medication use.

Programs have been started to improve medication use, but none have utilized rewards points or incentives as contemplated by the present invention. Under the Medicare Modernization Act of 2003, a medication therapy management program (MTM) is a program of drug therapy management that may be furnished by a pharmacist and that is designed to assure targeted beneficiaries that covered Medicare part D drugs under a prescription drug plan are appropriately used to optimize therapeutic outcomes through improved medication use, and to reduce the risk of adverse events, including adverse drug interactions (42 U.S.C. §1395w-104(c)). Under the statute, individuals targeted by MTM programs are those who 1) have multiple chronic diseases (e.g., diabetes, asthma, hypertension, hyperlipidemia, and congestive heart failure), 2) are taking multiple drugs covered under Medicare part D, and 3) are identified as likely to incur annual costs for covered part D drugs that exceed a specified level.

Although Congress mandated the provision of MTM services only to such recipients, eleven national pharmacy organizations have agreed upon a more expansive definition of MTM as a set of services provided by pharmacists or other qualified health care providers. Such services may include: performing or obtaining assessments of patient health status; formulating a medication treatment plan; selecting, initiating, modifying and/or administering medication therapy; monitoring and evaluating patient response to therapy, including safety and efficacy; performing a comprehensive medication review to identify, resolve, and prevent medication related problems, including adverse drug events; documenting the care delivered and communicating essential information to a patient's primary care providers; providing verbal education and training designed to enhance patient understanding and appropriate use of medications; providing information, support services, and resources designed to enhance patient compliance with therapeutic regimens; and coordinating and integrating MTM services within the broader health care management services provided to patients. These programs primarily rely on patients being identified in pharmacies or through call-centers, and do not have incentive programs in place.

Because of its wide-reaching scope, the MTM service model represents an improvement over the pharmacy benefit management system model (which focuses principally on drug-based issues), and the disease management system model (which focuses principally on a patient's disease).

Pharmacy benefit management companies (PBMs) currently use software programs to identify certain drug-related problems. Examples of such companies include Caremark, Medco, and Pharmacare. Because PBMs manage only pharmacy claims, though, the drug-related problems identified are restricted to problems which are “drug only.” In other words, PBMs identify only high dosages, low dosages, drug-to-drug interactions, non-formulary drugs, early refills, late refills, therapeutic duplication (two dispensed drugs perfoiming essentially the same function in the body), drug-gender interactions, and drug and dosage checks based upon age. When PBMs identify such problems, an electronic message is transmitted to the dispensing pharmacy at the time of claim submission to alert the pharmacist of the potential problem. In addition, many PBMs also send letters and/or faxes, and occasionally place telephone calls to prescribers to alert them of the potential problem. There is no guarantee, however, that these pharmacy or prescriber alerts are acted upon, and there is no consistent mechanism in place to ensure that the problem is actually resolved.

Disease management companies (DMs) partner with individual patients through their employer or health plan to provide disease-specific health and wellness education, and training. Examples of such companies include Healthways, Health Management Corporation, and Matria. The most common diseases for which DMs provide service are diabetes, asthma, smoking cessation, hypertension, multiple sclerosis, and hepatitis C. With regard to drugs, drug-related problems, and acute diseases, however, DMs do not provide consistent programs for identifying or resolving drug-related problems because their drug-related services are focused principally on ensuring that directions for use are reinforced and compliance with therapy is maintained. While some DM companies have established incentive programs for completing their programs, none of these have been specific to appropriate medication use.

To address the shortcomings of PBMs and DMs, a few companies have developed methods of providing MTM services, but the services provided and the methods by which they are provided are distinct from those of the present invention. For example, Community MTM Services, Inc. (Community MTM) is a provider of MTM services and a subsidiary of the National Community Pharmacists Association (NCPA). Community MTM contracts with PBMs and employers to provide MTM services through the NCPA's network of independent community pharmacies (approximately 24,000 across the United States). Community MTM uses documentation software that allows collection of data in a common format for the purposes of reporting back to their clients and for determining compensation to their network. The company also utilizes basic Medicare-dictated criteria to identify patients needing MTM services, and then provides this information to a local pharmacist who is willing to provide the service. Pharmacists then have an open window of time (typically several weeks) to contact the eligible patient, invite them to the pharmacy for a face-to-face MTM encounter, document the encounter using the documentation software, and transmit the information collected to Community MTM. Afterward, payment is sent to the pharmacy for providing the service. The patient receives no incentive to participate in the service other than the expectation of better care being provided to them. If the pharmacist does not act or provide service to the identified patients, then the patients continue to roll back onto the eligibility list period after period. However, Community MTM has no system in place to ensure that all eligible patients receive MTM services through their system. Additionally, Community MTM's system does not create a longitudinal patient care record. Pharmacists document the services they perform related to the billing event, but this does not build a patient record over time. The Community MTM system does not create a “portal” for the patient/consumer to participate/view their medication records or set up reminders.

Another provider of MTM services is Outcomes Pharmaceutical Health Care (Outcomes), which uses a web-based documentation and billing system in conjunction with its network of pharmacists. Outcomes identifies eligible patients based upon the Medicare criteria of multiple chronic diseases, multiple drugs covered under Medicare part D being taken, and likelihood of incurring annual costs for covered part D drugs that exceed a specified level. Outcomes has two methods of providing MTM services to eligible patients: either Outcomes identifies eligible patients and notifies a willing pharmacist MTM provider; or a pharmacist MTM provider can use the web-based Outcomes benefit package to identify a needed patient intervention, provide the MTM service, and then bill Outcomes for the service. Similar to Community MTM's system, Outcomes' system is also transaction oriented. The pharmacist documents the event-focused care for a billing purpose, but an ongoing patient record is not created. The present invention creates a complete patient record and is centered on a care process, not a billing process. Outcomes' system does have a disease-specific module related to the care of patients with diabetes which instills a process for caring for patients with the disease, but it does not have follow-up communications methodology for interventions. The present invention ensures that all care provided for any disease state has a HIPAA compliant, comprehensive communication follow-up process with the patient, the provider, the pharmacist and any other party involved in the care of the patient. The Outcomes system also does not provide the patient access to their medication records. None of the systems identified in the prior art have a component specific to adherence to medications or establishing rewards/points for the achievement of improved adherence or other health outcomes.

### BRIEF SUMMARY OF THE INVENTION

The present invention is an adherence program useful for improving medication use. The invention is an internet-based solution that serves as a consumer portal to improve patient adherence and persistence with chronic medications. Access is free of charge to patients (consumers), with a home page providing information on various problems caused by inappropriate and non-adherent medication use. Consumers may register at the site, receiving a username and password for secure access. Once secure access is gained, registered consumers may enter a personalized site, with their name and demographic information appearing. Then, they may enter their medications into a medications database to create a medication profile for all of their medications. Chronic medications appearing in the registered consumer's profile generate points for each refill date entered and verified accurate, as depicted in TABLE 1.

TABLE 1
Examples of patient actions which may be awarded points

| Description | Points | Frequency |
|---|---|---|
| New Chronic R_{X} | 100 | Not applicable |
| Timely refill | 50 | Up to every 30 |
| | | days |
| Completing educational program and passing | 200-600 | No more than |
| end-program test | | monthly |
| Immunizations (e.g.: flu shots; hepatitis B; | 200 | As appropriate |
| tetanus; Zostivax; etc.) | | |
| Appropriate health screenings (e.g.: eye | 200 | As appropriate |
| exam; PSA; annual physical; mammogram; | | |
| colonoscopy; etc.) | | |
| Achieving appropriate outcomes measures | 1000 | As appropriate |
| (e.g., LDL levels; A1c <7%; BMI 18.5-25; | | |
| BP <130/80 or 140/90, as appropriate) | | |
| Counseling session with registered pharmacist | 250 | As appropriate |

Other actions by registered consumers may also generate points, including but not limited to those shown in TABLE 1.

Verification logistics will have to be worked out more thoroughly for non-PharmMD client users. A non-registered patient (31) would register manually and become registered (40), (60). This could occur manually via fax or mail, through agreements with pharmacies and permission from patients to share their data, via drug companies or IMS, or some other means. For registered patients (60) (and we may have to limit PharmMinder®'s use to PharmMD clients, but if so, this could still be a big way to drive behavior change), claims and other data may be auto-populated (80). Users can also click on a “Print Medication List” button to generate a Personal Medication Record LPMR). A PMR consists of a list of the medications that the patient is taking. Later versions may include the ability to automatically send the PMR to a physician or other designated email address.

Registered patients (60) may also select various methods for receiving refill reminders (90), including “Monthly” and “Daily” options with personal phone calls (monthly only), automated phone calls, emails, text messages, post cards, etc. (100).

Registered patients (60) may also view a points summary (not shown). Registered consumers (60) earn points for refilling their chronic medications on time (see, e.g., TABLE 1). These points may be redeemed (140) for various rewards, including but not limited to merchandise, travel, and restaurants. Registered consumers (60) may also earn points by completing educational programs specific to their diseases (110).

An “If price is an issue” button could be added that would search for lower-priced and/or generic alternatives.

If a patient is non-adherent, rules could be triggered that would automate an IVR-based phone call with a Barrier Assessment survey.

Users could automate a refill request to a pharmacy or physician's office.

“Ask a pharmacist” or “Chat with a pharmacist” features could be added to enable users to submit a question or chat directly with a pharmacist on drug questions.

Users could print drug information leaflets and drug information leaflets on their medications.

Patients could also enter their medical conditions and other information to keep their own Personal Health Record. This could be integrated in multiple ways for sharing with hospitals, new/other physicians, etc for coordinated care.

PharmMD could run its rules against the data to identify areas where patients could improve their drug therapy based on their medical conditions.

### DEFINITIONS

By “compliance” and/or “adherence” as used herein is meant taking the prescribed amount of a prescribed medication at the proper time. Consequently, “non-compliance” and “non-adherence” are the failure to take the prescribed amount of a prescribed medication at the proper time. Compliance or non-compliance of individual patients may be measured, monitored, or estimated by, for example, tracking the refill history for any or all of a patient's prescription medications.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 is a flow diagram of a method for improving adherence and outcomes with medication use through a points-based incentive reward program.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

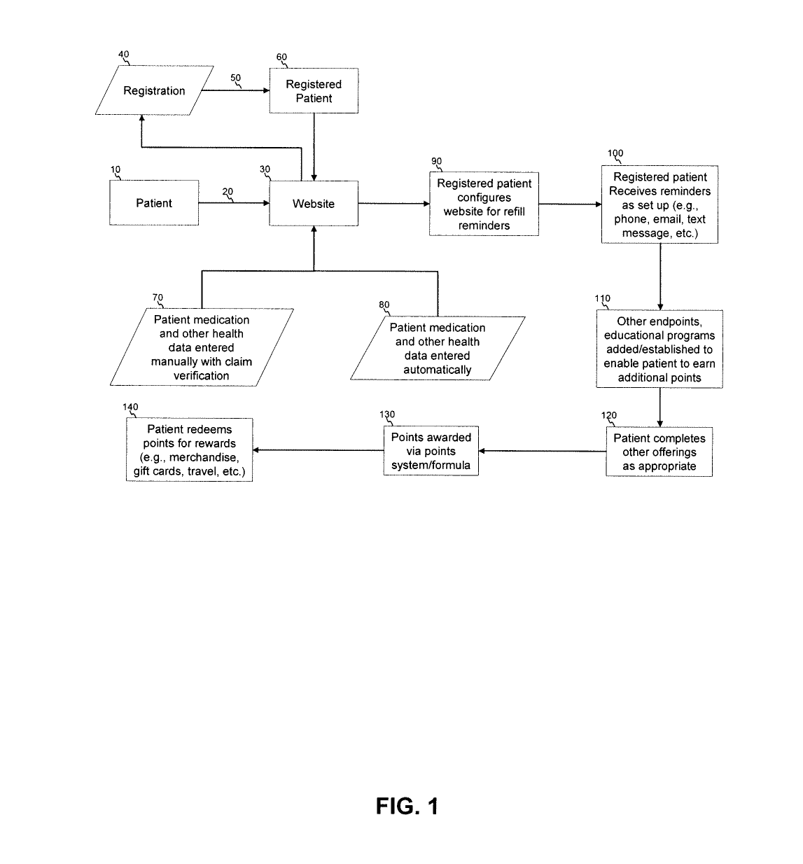

A flow diagram of a method for improving adherence and outcomes with medication use through a points-based incentive reward program is shown in the block diagram of FIG. 1. A patient (10), via telecommunications means (20), accesses website (30), whereby the patient may register (40) and receive (50) a username and password, thereby becoming a registered patient (60). Registered patients (60) may enter medication and other health-related data manually (70), along with claim verification information (70), or they may have the information entered manually for them. Registered patients (60) may also have their medication and other health-related data entered automatically (80). Registered patients (60) may then schedule refill reminders (90), choosing the time, place, manner, and delivery of said reminders (e.g., a non-limiting example of a scheduled refill reminder would be: 25 days after each previous refill, placing a telephone call to a specified telephone number, at a certain time). Registered patients (60) with refill reminders (90) would then receive them (100) as scheduled (90). Alternatively, if a registered user indicates that price is an issue (91) in the ordering decision, the system can be checked for less expensive substitutes or generics, and the user can select or refuse the proposed substitute.

Other measurable outcomes (110) are also established (including but not limited to educational programs) whereby registered patients (60) may earn additional points. A non-limiting example would be wherein a registered patient (60) may access an educational module (110), whereby information concerning a disease or diseases for which said registered patient is receiving treatment is delivered to the registered patient. Upon entry of certain verifiable input from the registered patient (e.g., entry of the correct answers to a quiz over the information delivered), points may be awarded. Registered patients (60) may also complete other offerings (120), as appropriate. Points are awarded (130) to registered patients (60) according to a system or formula, and are based upon said patients' verifiable activities. Non-limiting examples of such verifiable activities and their frequency, along with non-limiting examples of the points that may be awarded for the activities, are shown in TABLE 1. Registered patients (60) may redeem points (140) for rewards (including, but not limited to, merchandise, gift cards, travel, etc.).

The present invention addresses the aforementioned shortcomings of the prior art. In addition, the present invention provides for rewards points that enable the user to earn points that can be redeemed for prizes (e.g. merchandise, store gift cards, travel, etc) which do not exist in any other program/system. The present invention integrates a medication profile (70, 80) with the ability to select reminders (90, 100) to be delivered automatically (e.g., phone call, automated phone call, email, text message, etc.) and configured for the desired times corresponding to the times the medication is to be taken and/or the times/dates the medication needs to be refilled for continued use (90, 100). Points are awarded for continued use and accumulate over time (130). Additional points can also be earned by completing educational modules (110) and for achieving desired medication (120) and health-related outcomes (120) including but not limited to lab values (e.g. alc, LDL), utilization of appropriate medications by evidence based guidelines, etc. (120). Points may be redeemed (140) for rewards, including but not limited to merchandise, subscriptions, gift cards, and travel. There is currently no similar invention which provides fully-automated refill reminders with rewards points.

In a method according to an embodiment of the present invention, pharmacy claims data for beneficiaries of a prescription drug benefit plan are obtained (80). Additional data regarding the beneficiaries is also obtained (not shown). Examples of data obtained include pharmacy claims, medical claims (e.g., physician visits, hospital visits, etc.), beneficiary demographic and occupational data, clinical laboratory data, health risk assessment data, and medication risk assessment data. Depending on the data available, the data is then checked to ensure its accuracy and integrity (not shown). Characteristics of data sought are identified, the data is then organized and structured according to those characteristics, and the data is entered automatically (80). In another method according to an embodiment of the present invention, pharmacy claims data is entered manually and verified (70). This can be done either by the patient or through staff Data can either be added to the system via claims or manually entered by the patient via a secure website and subsequent claim validation (70).

A set of clinical rules, desired endpoints, and preventive health care measures (e.g. vaccinations, screenings, etc.) is established, using such criteria and information as that published by the Agency for Healthcare Research and Quality (AHRQ, an arm of the U.S. Department of Health & Human Services), the American Medical Association (AMA), and other agencies and organizations generally recognized and accepted as creating and publishing quality measures in health care, as well as information available from evidence-based medical literature which may provide further guidance and/or improvements upon existing published quality measures (not shown). The clinical rules and desired endpoints, and preventive health care measures are then used to establish a points system to reward users for appropriate use of medication(s) and health care (e.g., as shown by the non-limiting examples of TABLE 1).

A formulary may be incorporated into the analysis step (not shown), whereby the recommendations output is customized so formulary items are recommended, where possible, and points are awarded.

Pharmacy and medical claim data may also be obtained (70) directly from the patient (60). Points are awarded (130) upon verification of the consumer-submitted claim(s).

The data is stored in a relational database which is encrypted in situ. The data is kept indefinitely.

The data is not de-identified when entered into the system because the present invention involves a care process which is patient-specific and requires follow-up with specific patients to ensure appropriate awarding of points and medical and pharmacy claims tracking.

Through these methods, the present invention enables consumers to be more highly motivated and engaged in adhering to their prescribed medications and achieving desirable health endpoints. This results in improved patient health and significant cost savings to the healthcare system, as well as improved employee productivity. In addition, the present invention vastly improves the care process for medication use. Prior to the present invention, consumers/patients would go to the doctor to get a condition diagnosed and treated. The physician would prescribe treatment and would assume the patient completed the course of therapy. Especially in the case of chronic conditions where medications are required to be taken for months to years before seeing the benefit, patients often 40%-60% of the time, stop taking the medications resulting in waste in dollars spent and resources utilized. This leads to significantly fewer medication-related hospitalizations, fewer medication-related adverse events requiring further treatments, fewer emergency department visits, fewer unnecessary visits to physician offices, fewer missed days from work, fewer medication-related deaths, and an improved quality of life for patients taking medications which are intended to be life-saving. The present invention solves existing medication-related problems and then continuously provides education and monitors the patient's medical and pharmacy care to ensure the patient does not develop any new medication-related problems. This invention is the first to provide prospective refill reminders connected to a rewards program to improve engagement of patients and in their medication use and education and monitoring of their health condition(s) in this manner.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A method for improving medication adherence and outcomes, said method comprising:
registering a patient in a predetermined manner with a web site, thereby creating an associated user profile;
manually entering patient medication data and patient health data associated with said user profile;
automatically acquiring from a third party and then storing patient medication data and patient health data associated with said user profile; and
assigning a points based reward based on a comparison of at least one of said manually entered data and said automatically acquired data to a predetermined set of reward criteria parameters.

2. The method of claim 1, wherein said manually entering data further comprises entering data relating to one or more of a medication name, a medication dosage, a medication start date, a medication stop date, a medication use statement, a mandatory medication administration schedule, and a discretionary medication instruction schedule.

3. The method of claim 1, wherein said automatically acquiring data further comprises acquiring data from one or more of a pharmacy benefit manager, an insurance company, a pharmacy, and a prescription processor.

4. The method of claim 1, wherein said storing data further comprises storing data relating to one or more of pharmacy claim data, medical claim data and lab data.

5. The method of claim 1, wherein configuring said user profile further comprises configuring said profile to issue a reminder to said user that a medication refill will become due within a predetermined timeframe, and reminding said user to initiate said refill.

6. The method of claim 5, wherein said user reminder further comprises a reminder to administer said medication.

7. The method of claim 6, wherein said reminder further comprises a reminder conveyed by means of one or more of a telephone call, an electronic mail, and a text message.

8. The method of claim 5, wherein said user profile is configured to track a past medication refill history.

9. The method of claim 1, wherein said user profile further comprises one or more educational modules relating to a predetermined selection of health topics.

10. The method of claim 9, wherein said predetermined selection of health topic modules further comprises one or more modules relating to medications, medical conditions, family histories, and health risk factors, and wherein each of said modules further includes a user test regarding the subject matter discussed therein.

11. The method of claim 10, wherein after a user completes a module test and obtains a predetermined passing score, the user is awarded points that can later be redeemed in accord with a set of predetermined reward program parameters.

12. The method of claim 1, further comprising tracking one or more preventative health tracking criteria, tracking one or more vaccination tracking criteria, and awarding points to a user for compliance with said preventative health and vaccination criteria.

13. The method of claim 12, wherein said tracking preventative health criteria further comprises tracking one or more of a mammogram and a prostate examination.

14. The method of claim 12, wherein said tracking vaccination further comprises tracking one or more of an influenza vaccination, a pneumonia vaccination, and a tetanus vaccination.

15. The method of claim 1, further comprising:
comparing acquired lab data to a predetermined set of performance criteria, and awarding points to a user based on compliance with said set of predetermined performance criteria.

16. The method of claim 15, wherein said comparing a set of performance criteria further comprises comparing data relating to one or more of blood pressure related data, cholesterol related data, weight control related data, medication administration compliance data, and data relating to health data performance standards promulgated by third parties.

17. The method of claim 1, further comprising: tracking points earned through said points based reward system.

18. The method claim 17, further comprising: redeeming earned points through an associated points redemption program.

19. The method of claim 18, wherein said redeeming earned points further comprises redeeming said points for a predetermined selection of one or more of a gift card, merchandise related benefits and travel related benefits based upon the number of points earned and tracked.
